(19) United States
(12) Patent Application Publication
(10) Pub. No.: US 2024/0413293 A1
(43) Pub. Date: Dec. 12, 2024

(54) SOLVENT-FREE ELECTRODE AND SOLID-STATE ELECTROLYTE MANUFACTURING PROCESS

(71) Applicant: Valgotech LLC, Fishers, IN (US)

(72) Inventors: David O. Olawale, Carmel, IN (US); Sajibul Alam Bhuyan, Indianapolis, IN (US)

(73) Assignee: Valgotech LLC, Fishers, IN (US)

(21) Appl. No.: 18/734,133

(22) Filed: Jun. 5, 2024

Related U.S. Application Data
(63) Continuation of application No. PCT/US2024/032418, filed on Jun. 4, 2024.
(60) Provisional application No. 63/506,683, filed on Jun. 7, 2023.
(60) Provisional application No. 63/506,683, filed on Jun. 7, 2023.

(51) Int. Cl. H01M 4/04; H01M 4/139

(52) U.S. Cl. CPC H01M 4/0404; H01M 4/0435; H01M 4/0471; H01M 4/139

(57) ABSTRACT

A solvent-free process has been developed for manufacturing of lithium metal battery electrodes, lithium-ion batteries electrodes, and solid-state batteries electrodes and electrolytes. In one embodiment, a combination of micropores/microchannels for the dispersing and depositing the blended battery electrode or electrolyte particles on to a surface and hot press mechanism is provided to achieve particles adhesion among themselves and onto the substrate surface. Further described is a manufacture of multilayer solvent-free electrodes and solid-state electrolytes.

### CROSS REFERENCE TO RELATED APPLICATIONS

This application is a continuation of International Patent Application Number PCT/US2024/032418, filed Jun. 4, 2024, which is hereby incorporated by reference. International Patent Application Number PCT/US2024/032418, filed Jun. 4, 2024, claims the benefit of U.S. Patent Application No. 63/506,683, filed Jun. 7, 2023, which are hereby incorporated by reference. This application claims the benefit of U.S. Patent Application No. 63/506,683, filed Jun. 7, 2023, which is hereby incorporated by reference.

### BACKGROUND

With the rising popularity of smartphones, battery electric vehicles (BEVs), and other portable electrically powered devices, there has been an increased demand for rechargeable batteries such as lithium-ion batteries. However, fabrication of such batteries and other electronic components can be an expensive and time-consuming process.

Thus, there is a need for improvement in this field.

### SUMMARY

A unique solvent-free process has been developed for producing electrodes and solid-state electrolytes that are useful for high density energy storage devices such as for lithium sulfur (Li—S), lithium-ion batteries (LIB), and solid-state batteries (SSB). Conventional energy-dense electrodes are typically fabricated by using a slurry coating method (wet process) with organic solvents. However, there are several drawbacks with these solvent or liquid-based methods. For example, in solid state batteries (SSB), the thickness of electrodes is expected to reach 150 μm in order to construct an energy-dense battery with >400 Wh/kg because the electrolytes constitute an indispensable part of solid-state electrolytes (SSEs) for ionic conduction.

Many SSEs are sensitive to organic solvents for slurry preparation, resulting in a series of negative effects such as dissolution, complexation, and degradation. The thick electrodes usually absorb high amounts of the solvents. Rapid solvent evaporation will leave pores and increase the porosity of the electrodes resulting in high ionic tortuosity in solid-state batteries. This increased porosity degrades the performance of the battery.

After the thick electrode is formed with the wet process, the freshly applied slurry gradually settles to form a concentration gradient during the prolonged drying processes. The binder gradient and the uneven distribution of electrode components with high mass loading results in poor mechanical strength and poor mechanical performances such as cracking, power drops, and peeling. In thick electrodes, the ionic tortuosity influences battery performance such as in solid-state batteries. In conventional liquid-based techniques, the electrodes are submerged in organic electrolytes. The electrolytes can infuse through the electrode microstructures and partly swell the binder to afford ion transportation. Voids and binder distribution impact ionic tortuosity, and the ionic tortuosity in turn impacts cathode utilization.

The manufacturing processes of conventional batteries exhibit limited compatibility with thick electrode fabrication for next generation high energy density Li metal batteries and solid-state batteries. The solvents are expensive and hazardous. Due to the hazardous nature of the solvents, expensive solvent recovery processes are required which can be a big technical challenge. Upgrading any existing manufacturing processes to produce thicker electrodes is challenging and costly.

The unique solvent-free process addresses these as well as other issues. With this process, harmful conventional organic solvents are not required to manufacture high energy density and high-capacity Li-metal, LIB, or solid-state electrodes and electrolytes as well as other electrical components.

This process for solvent-free sheet-type electrode manufacturing begins with a dry active material ball milled with carbon material, dry conductive particles, and dry binder material. Next, the dry binder material, dry conductive material and dry active particle are ground to form a dry mixture up to a targeted particle size. This transformation provides uniform dispersion on the current collector surface. Next the dry mixture powder is diffused in a dispersion step using vibrational, translational, rotary and/or gravity-induced dispersion and flow of the mixed particles through a microporous/microchannel membrane, disc, or drum. The microporous/microchannel membrane, disc, or drum is designed based on particle sizes. The size of the micropores controls the diffusion/deposition rate of dry mixture particles. The external motion (vibration/rotation/gravity-induced, etc.) provides smooth and uniform dispersion of the particle on the current collector. Also, these forces can be adjusted for multi-layer dispersion on the surface which results in a multi-layer electrode. After the dispersion step, the dry mixed powder is ready for dry coating using the powder-to-film process. The hot-pressing procedure at certain temperatures (60° C.˜180° C.) depending on the binder type, with pressure (2 ton˜ 5 ton) and pressing duration makes a uniform dry film sheet using the thermoplasticity characteristics of the binder. At a certain temperature both active material and binder become fused together and formed by hot pressing. In other embodiments, UV activated binder may be used. In this instance, a UV lamp is placed after the particles (powder) deposition and before the pressing/rolling station. Most importantly, additional pressure enhances the adhesiveness between the active material and current collector. This pressure also helps to reduce the ionic tortuosity by reducing the thickness of the electrode and eliminating voids. Finally, the calendaring step (optional) ensures the target electrode thickness and provides additional adhesiveness for the solvent free electrode sheet.

A hot pressing system has been developed for the dispersion step and the hot pressing step. The system includes a hopper and a sifter to disperse and deposit dry electrode or electrolyte particles or powder on a substrate. The sifter can be a microporous/microchannel membrane, disc, or drum. The sifter is attached to the hopper from the bottom. The micropore size of the sifter controls the diffusion/deposition rate of dry mixture powder. The dry mixture powder in turn is disposed into the hopper, and dispersed on the substrate through the sifter. In some embodiments, an external motion is applied to provide smooth and uniform dispersion of the particle. For example, the external motion can be vibration, rotation, or gravity-induced.

The substrate in the system includes a deposition station, a curing station, and a calendaring station. The substrate is driven by a supply roll and a take up roll. The substrate can be a conveyance belt with sufficient width for laying the sheet-type electrode. The supply roll and the take up roll can be motorized cylinders which drive the substrate, so as to transport the dry mixture powder on the substrate from the deposition station to the curing station, and further to the calendaring station. The curing station of the substrate can be supported by a supporting plate or supporting rollers beneath and be pressed by a corresponding reciprocating hot press or roller hot press from upward. The hot press and/or supporting plate/rollers can be heated to a temperature ranging from about 80° C. to about 180° C., depending on the type of binder. The pressure between the reciprocating hot press plate and the supporting plate can range from about 2 ton to about 5 ton when the forces are applied. The calendaring station is an optional treatment, which comprises two calendaring rollers. One calendaring roller is located above the substrate and the other calendaring roller is below the substrate. The calendaring roller can be cylinders with their axes parallel to the substrate and perpendicular/transverse to the moving direction of the substrate. The distance between the calendaring rollers is adjusted to ensure a desired thickness of the sheet-type electrodes.

In one embodiment, the dry mixture powder is first filtered through the sifter and deposited on the deposition station of the substrate. The conveyance belt transports the dry mixture powder from the deposition station to the curing station. On the curing station, the hot press exerts a compressive force to the dry mixture powder on the substrate, while the supporting plate/rollers support the substrate from beneath. At a certain temperature both the active material and binder become fused together and bonded into a uniform dry film sheet by hot pressing. In some embodiments, an optional UV lamp is placed between the deposition station and the curing station. The UV light promotes activation of the binder in the dry mixture powder before or/and after hot pressing. After hot pressing, the conveyance belt transports the dry film sheet to the calendaring station. On the substrate of the calendaring station, a secondary pressure is applied on the dry film sheet when the dry film sheet passes through the top calendaring roller and the substrate above the bottom calendaring roller. This additional pressure enhances the adhesiveness between the active material and current collector. This pressure also helps to reduce the ionic tortuosity by reducing the thickness of the electrode and eliminating voids. The process herein can additionally be used to manufacture multilayer solvent-free electrodes and multilayer solid-state electrolytes.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a supply roll.

Aspect 3 generally concerns the system of any previous aspect including a take up roll.

Aspect 4 generally concerns the system of any previous aspect including a substrate fed between the supply roll and the take up roll.

Aspect 5 generally concerns the system of any previous aspect in which the substrate includes a sheet.

Aspect 6 generally concerns the system of any previous aspect in which the substrate includes a film.

Aspect 7 generally concerns the system of any previous aspect including a deposition station.

Aspect 8 generally concerns the system of any previous aspect in which the deposition station includes a hopper.

Aspect 9 generally concerns the system of any previous aspect in which the deposition station has a microporous membrane.

Aspect 10 generally concerns the system of any previous aspect in which the deposition station has a disc or plate with micropores or microchannels.

Aspect 11 generally concerns the system of any previous aspect in which the deposition station has a drum or shaft with micropores or microchannels.

Aspect 12 generally concerns the system of any previous aspect in which the micropores or microchannels have a size of about 10 μm-300 μm.

Aspect 13 generally concerns the system of any previous aspect in which the deposition station is configured to disperse powder through the micropores or microchannels.

Aspect 14 generally concerns the system of any previous aspect in which the deposition station is configured to disperse powder through motion, vibration or/and gravity-induced dispersion.

Aspect 15 generally concerns the system of any previous aspect including a curing station.

Aspect 16 generally concerns the system of any previous aspect in which the curing station includes a press.

Aspect 17 generally concerns the system of any previous aspect in which the press includes a hot reciprocating plate type press.

Aspect 18 generally concerns the system of any previous aspect in which the press includes a hot roller-plate type press.

Aspect 19 generally concerns the system of any previous aspect in which the press includes a hot roller type press.

Aspect 20 generally concerns the system of any previous aspect in which the press has a temperature of about 60° C. to 200° C.

Aspect 21 generally concerns the system of any previous aspect in which the press includes one or more rollers.

Aspect 22 generally concerns the system of any previous aspect in which the rollers are motorized rollers.

Aspect 23 generally concerns the system of any previous aspect in which the rollers are heated rollers.

Aspect 24 generally concerns the system of any previous aspect in which the rollers are configured to exert a compressive force on dispersed or deposited materials on a collector or membrane with a supporting plate or roller.

Aspect 25 generally concerns the system of any previous aspect in which the curing station includes ultraviolet curing equipment.

Aspect 26 generally concerns the system of any previous aspect including a calendaring station.

Aspect 27 generally concerns the system of any previous aspect in which the calendaring station includes one or more calendaring rollers.

Aspect 28 generally concerns the system of any previous aspect in which the supply roll is configured to supply a substrate.

Aspect 29 generally concerns the system of any previous aspect in which the deposition station is configured to dispense a dry mixture onto the substrate.

Aspect 30 generally concerns the system of any previous aspect in which the dry mixture includes carbon particles, conductive particles, and dry binder particles.

Aspect 31 generally concerns the system of any previous aspect in which the deposition station defines micro-sized openings through which the dry mixture is uniformly deposited onto the substrate.

Aspect 32 generally concerns the system of any previous aspect in which the micro-sized openings have a size of about 10 μm-300 μm.

Aspect 33 generally concerns the system of any previous aspect in which the micro-sized openings have a hydraulic diameter of about 10 μm-300 μm.

Aspect 34 generally concerns the system of any previous aspect in which the micro-sized openings include micropores.

Aspect 35 generally concerns the system of any previous aspect in which the micro-sized openings are micropores.

Aspect 36 generally concerns the system of any previous aspect in which the micro-sized openings include microchannels.

Aspect 37 generally concerns the system of any previous aspect in which the micro-sized openings are microchannels.

Aspect 38 generally concerns the system of any previous aspect in which the curing station is configured to bind the binder particles with the carbon particles and the conductive particles to form a solid layer of the dry mixture on the substrate.

Aspect 39 generally concerns the system of any previous aspect in which the solid layer forms a solid-state electrolyte (SSE) of a battery.

Aspect 40 generally concerns the system of any previous aspect in which the solid layer forms an electrode of a battery.

Aspect 41 generally concerns the system of any previous aspect including a milling station configured to mill the dry mixture.

Aspect 42 generally concerns the system of any previous aspect in which the milling station is configured to supply the dry mixture to the deposition station.

Aspect 43 generally concerns the system of any previous aspect in which the milling station includes a ball miller configured to ball mill the dry mixture.

Aspect 44 generally concerns the system of any previous aspect in which the calendaring station is configured to flatten the solid layer of the dry mixture on the substrate.

Aspect 45 generally concerns a method.

Aspect 46 generally concerns the method of any previous aspect including a method of manufacturing with the system.

Aspect 47 generally concerns the method of any previous aspect including milling active dry materials with carbon nanomaterials.

Aspect 48 generally concerns the method of any previous aspect in which the active dry materials are ball milled with the carbon nanomaterials.

Aspect 49 generally concerns the method of any previous aspect including mixing dry binder with the active dry materials.

Aspect 50 generally concerns the method of any previous aspect including mixing dry conductive particles with the dry binder.

Aspect 51 generally concerns the method of any previous aspect in which the active dry materials, dry binder, and dry conductive particles are ground.

Aspect 52 generally concerns the method of any previous aspect including blending the active dry materials, dry binder, and dry conductive particles to form a powder.

Aspect 53 generally concerns the method of any previous aspect including diffusing and/or dispersing the powder onto a substrate.

Aspect 54 generally concerns the method of any previous aspect in which the substrate is a sheet.

Aspect 55 generally concerns the method of any previous aspect in which the substrate is a film.

Aspect 56 generally concerns the method of any previous aspect including curing the powder.

Aspect 57 generally concerns the method of any previous aspect in which the powder is heated and pressed.

Aspect 58 generally concerns the method of any previous aspect in which the powder forms an electrode layer.

Aspect 59 generally concerns the method of any previous aspect in which the powder forms an electrolyte layer.

Aspect 60 generally concerns the method of any previous aspect in which the active materials for a dry electrode include 50%-95% weight for a sodium-ion/lithium metal/solid state battery.

Aspect 61 generally concerns the method of any previous aspect in which the active materials for the dry electrode include 70%-95% weight for a lithium-ion battery.

Aspect 62 generally concerns the method of any previous aspect including a method of manufacturing an electrode without using a solvent.

Aspect 63 generally concerns the method of any previous aspect in which the electrode is used with a solid-state electrolyte (SSE).

Aspect 64 generally concerns the method of any previous aspect in which the electrode is formed from a dry mixture.

Aspect 65 generally concerns the method of any previous aspect in which the dry mixture includes a carbon material, dry conductive particles, and a dry binder material.

Aspect 66 generally concerns the method of any previous aspect in which the dry mixture is ground to a target particle size to provide uniform dispersion.

Aspect 67 generally concerns the method of any previous aspect in which the dry mixture is ground using ball milling.

Aspect 68 generally concerns the method of any previous aspect in which the dry mixture is dispersed onto a substrate to form a layer for the electrode.

Aspect 69 generally concerns the method of any previous aspect in which the dry mixture is dispersed through micropores or microchannels.

Aspect 70 generally concerns the method of any previous aspect in which the dry mixture is dispersed through motion, vibration or/and gravity-induced dispersion.

Aspect 71 generally concerns the method of any previous aspect in which the layer of the dry mixture is hot pressed to fuse and bond the dry mixture.

Aspect 72 generally concerns the method of any previous aspect in which a reciprocating hot press performs the hot pressing.

Aspect 73 generally concerns the method of any previous aspect in which the hot pressing occurs at a temperature of about 50° C. to 200° C.

Aspect 74 generally concerns the method of any previous aspect including calendaring with calendaring rollers after the hot pressing.

Aspect 75 generally concerns the method of any previous aspect in which the active material in the dry mixture for an electrode in a lithium metal/solid state battery includes lithium, carbon, silicon, and/or a tin-cobalt alloy.

Aspect 76 generally concerns the method of any previous aspect in which the binder is an ultraviolet cured binder that is cured with ultraviolet light.

Aspect 77 generally concerns the method of any previous aspect including heating and pressing the powder.

Aspect 78 generally concerns the method of any previous aspect in which the dry mixture includes metal additives.

Aspect 79 generally concerns the method of any previous aspect in which the dry mixture includes carbon particles, conductive particles, metal additives, and/or dry binder particles.

Aspect 80 generally concerns the method of any previous aspect including mixing dry metal additives.

Aspect 81 generally concerns the method of any previous aspect including blending the active dry materials, dry binder, dry metal additives, and/or dry conductive particles to form a powder.

Aspect 82 generally concerns the method of any previous aspect in which the active dry materials, dry binder, dry metal additives, and/or dry conductive particles are ground.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a system according to one embodiment.

FIG. 2 is a top view of the FIG. 1 system.

FIG. 3 is a flowchart of a solvent-free manufacturing process according to one example.

FIG. 4 is a perspective view of the FIG. 1 system during the manufacturing process.

FIG. 5 is a perspective view of a further system according to a further embodiment with a hot roller-plate press.

FIG. 6 is a perspective view of another system according to another embodiment with a hot roller press.

FIG. 7 is a schematic of hot pressing or high-pressure pelletizing techniques.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

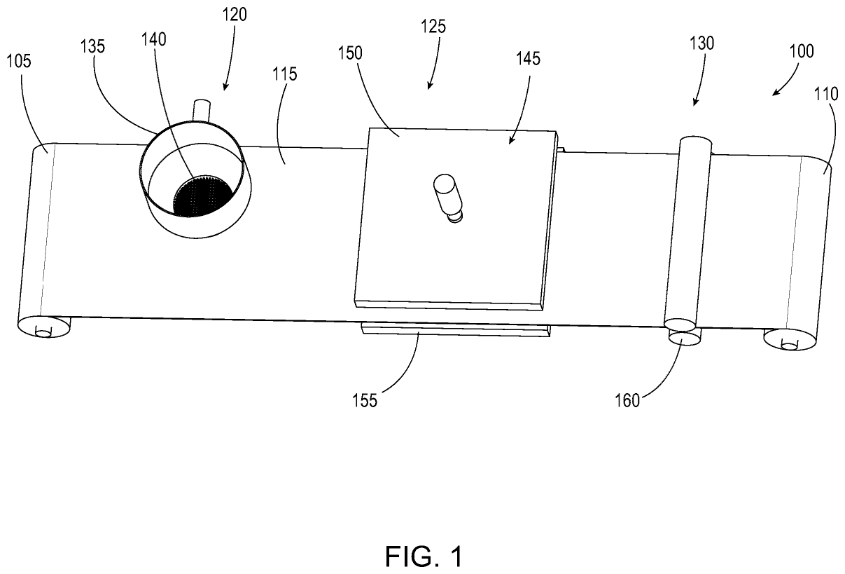

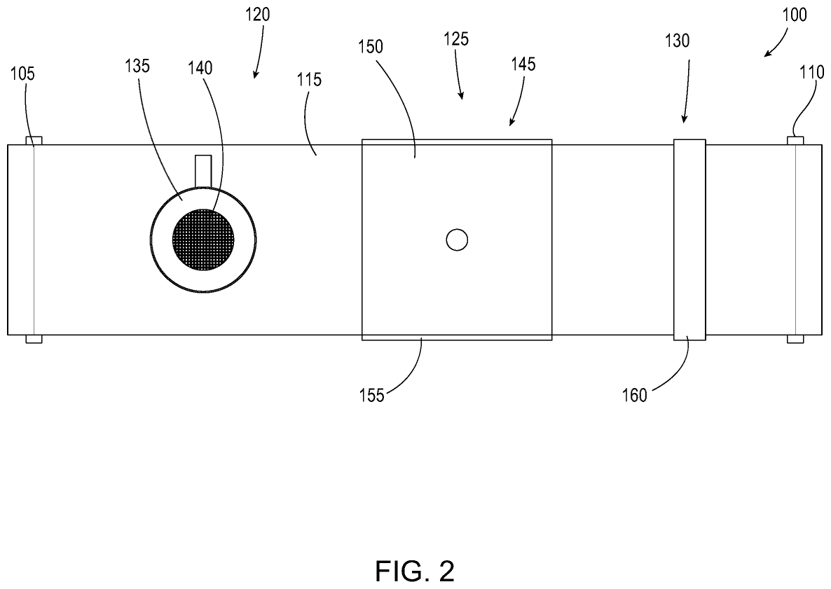

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIGS. 1 and 2 illustrate one example of a system 100 configured to perform the solvent-free electrode and solid-state electrolyte fabrication process described below. As shown, the system 100 includes a supply roll 105 and a take up roll 110. A sheet, film, or other substrate 115 is fed from the supply roll 105 to the take up roll 110. The system 100 includes a deposition station 120, a curing station 125, and a calendaring station 130. The supply roll 105 and take up roll 110 rotate to transport the substrate 115 from the deposition station 120 to the curing station 125 and the calendaring station 130. The deposition station 120 has a hopper 135 with a membrane 140 configured to disperse a dry powder onto the substrate 115 that forms the electrodes and/or solid-state electrolyte. The membrane 140 has microporous membranes or channels to enhance the uniform deposition of the battery materials. In the illustrated example, the curing station 125 has a press 145 in the form of a reciprocating hot press 150 and support plate 155. The press 145 cures and binds the powder on the substrate 115 by heating and pressing the powder on the substrate 115 between the reciprocating hot press 150 and support plate 155. The calendaring station 130 has one or more calendaring rollers 160 that further squeeze and/or press the cured powder layer on the substrate 115.

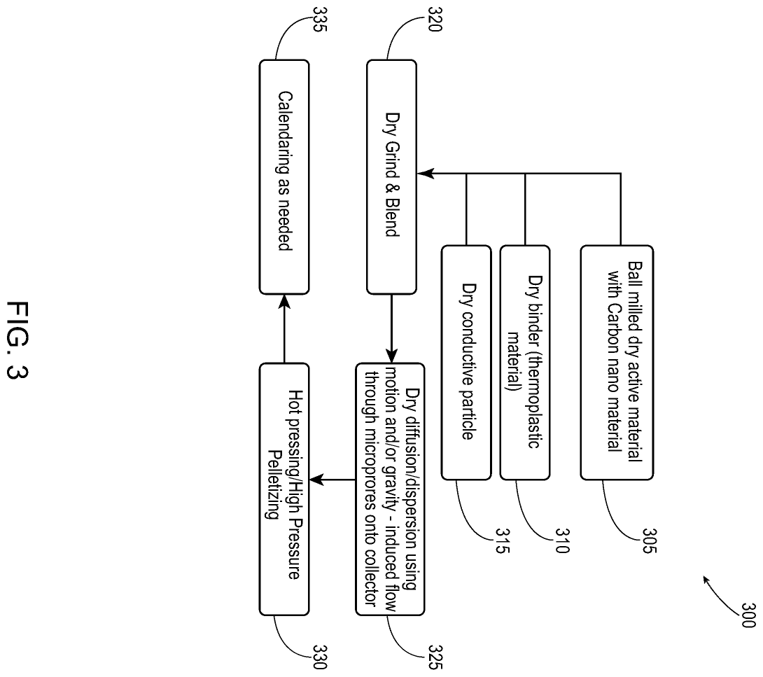

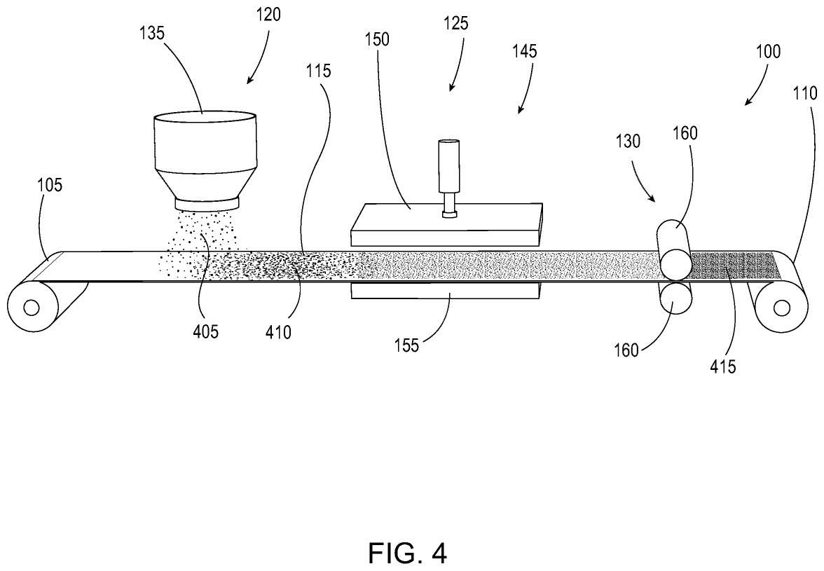

FIG. 3 shows a flowchart 300 of a manufacturing process for creating a solvent-free sheet-type electrode. To provide context, FIG. 4 illustrates an example of the system 100 of FIG. 1 using this process. A dry electrode includes a current collector for anode/cathode side. In stage 305, dry cathode active material is ball milled with a carbon nanomaterial. The dry cathode active material may include lithium nickel manganese cobalt oxide (NMC), lithium manganese oxide (LMO), lithium nickel manganese oxide (LNMO), lithium iron phosphate (LFP), lithium cobalt oxide (LCO), lithium titanate (LTO), and/or lithium nickel cobalt aluminum oxide (NCA) and sulfur-based material. In some embodiments, the dry active materials can also be composite cathode materials such as NM-NCA, NMC-LCO, NMC-NCA-LCO. In stage 310, a binder is processed and provided. In one form, the binder is a thermoplastic material. For example, the binder can be a polyolefin including polyacrylonitrile (PAN), polyethylene (PE), polypropylene (PP), polyvinylidene fluoride (PVDF), polyvinylene chloride, poly (phenylene oxide) (PPO), polyethylene-block-poly (ethylene glycol), polydimethylsiloxane (PDMS), polydimethylsiloxane-co-alkylmethylsiloxane poly (ethylene oxide) (PEO), co polymers thereof, and/or admixtures thereof as a plasticizer material. In other embodiments, the binder can include glucose as well as cellulose, for example, carboxymethyl cellulose (CMC). In stage 315, a dry conductive material in particle form, such as a carbon conductive material, is provided. In one form, the carbon conductive material includes graphitic carbon, graphite, hard carbon, soft carbon, ketjen black, super P and combinations thereof.

In some embodiments, the active material elements for a dry electrode are 50%-90% of the electrode by weight for lithium-ion/sodium-ion/lithium metal/solid state batteries. In other embodiments, the active material elements for a dry electrode are 50%-95% of the electrode by weight for lithium-ion/sodium-ion/lithium metal/solid state batteries and 70%-95% of electrode by weight for lithium-ion batteries. In some versions, the dry electrode cathode film includes up to 30% porous carbon material. In some forms, the dry film includes up to 10% conductive material and up to 15% binder by weight. In other forms, the dry film includes up to 30% conductive material, up to 30% metal additives, and up to 20% binder by weight. In certain variations, the dry electrode cathode film includes by weight up to 30% porous carbon material, up to 10% conductive material and up to 15% binder. The weight percentage of active material elements in a dry electrode ranges from about 50% to about 90% for sodium-ion/lithium metal/solid state batteries and ranges from about 70% to about 95% weight for lithium-ion batteries. The Li—S batteries can include about 35% to 90% sulfur by weight with other nano materials such as graphene, graphene oxide, carbon nano fibers, carbon nano tubes, and metal additives, like selenium and titanium. In another variation, the Li—S batteries can include about 40% to 90% sulfur by weight with the other the nano materials previously mentioned. Maxene and Borophene are also considered for use in this solvent free electrode fabrication technique.

In stage 320, the dry binder material, dry conductive material and dry active particles are ground and blended to form a dry mixture powder up to a targeted particle size. Electrodes and electrolytes are produced from the above-mentioned solvent-free manufacturing process for lithium metal (e.g., Li—S) batteries, lithium-ion batteries, and solid-state batteries. In one embodiment, the dry electrode mixture results from a combination of a plurality of types of constituent particles, including at least an active charge material and a binder. In one form, the dry active material is ball milled at approximately 20 Hz for about 30 minutes with carbon material, dry conductive particles, and dry binder material. The dry binder material, dry conductive material, and the dry active particles are then ground for about 15 to 20 minutes at about 1000 to 2000 rpm to form a dry mixture up to a targeted particle size. The dry binder material, the dry conductive material, and the dry active particles can be ground and ball-milled by a grinder and pestle before mixing to facilitate homogenous mixing. The dry ingredients are mixed at room temperature (e.g., at about 20-25° C.). The vibration/rotation of the material ingredients does not usually raise the temperature that much (approximately less than 40° C.), and the mixture is cooled down naturally before deposition. In one version, the targeted particle size is about 2 to 20 μm in size. The properties of the particles associated with the coating powder need not be the composite particles selected for an electrostatic deposition coating. The different powder materials can be mixed in a number of manners such as mechanically via stirrers and/or rotating drums.

In stage 325, the dry mixture powder is diffused using vibrational, translational, rotary and/or gravity-induced dispersion and flow of the mixed particles through a microporous/microchannel membrane, disc, or drum. This transformation provides uniform dispersion on the current collector surface. The microporous/microchannel membrane, disc, or drum is designed based on the particle sizes. The size of the micropores controls the diffusion/deposition rate of dry mixture particles. The external motion (vibration/rotation/gravity-induced, etc.) provides smooth and uniform dispersion of the particle on the current collector. This act involves a low energy (kinetic) deposition of the powder particles onto the substrate without the use of any spray gun. Also, these forces can be adjusted for multi-layer dispersion on the surface which results in multi-layer electrode. Referring to FIG. 4, the hopper 135 at the deposition station 120 dispenses the blended powder 405 onto the substrate 115 by sifting the powder 405 through the membrane 140 (FIG. 1) in stage 325 to form a powder layer 410 on the substrate 115. The membrane 140 in one form has micropores and/or microchannels to enhance the uniform deposition of the electrode or battery materials. The membrane 140 can come in a number of forms, such as including a mesh, sieve, grid, and/or lattice. The micropores or microchannels of the membrane 140 in some versions have a size of about 10 μm to 300 μm. The diameter of the membrane 140 in one version is 20 cm. This size of membrane 140 in other versions varies from 5 cm to 100 cm depending on the required width of the substrate 115. Since the uniform dispersion can be achieved with the micropores and/or microchannels, the particles are not necessarily aerated or fluidized. In some embodiments, the blended powder 405 can be dispersed continuously to form a band or discontinuously to form separate segments. It was discovered that the clearance distance between the membrane 140 of the hopper 135 and the substrate 115 plays a significant role for proper diffusion of the material on the substrate 115. This clearance distance of the hopper 135 above the substrate 115 further provides greater mobility or flexibility in movement of the hopper 135. In one example, the distance between the membrane 140 of the hopper 135 and the substrate 115 is about 10 cm. The dispersion rate is generally dependent upon the particle size of the powder, the size of the micropores/microchannels in the membrane 140, the back pressure applied to the dispensed powdered, and the velocity of the substrate 115 relative to the hopper 135. In some cases, the dispersion rate can be about 25 mg/sec and electrode loading can be 6 mg/cm² after hot pressing.

In stage 330, the deposited mixture is heated to activate the binder for adhering the mixture to the substrate, and the deposited mixture is compressed to a thickness for achieving an electrical sufficiency of the compressed, deposited mixture as an electrode in a battery. In one example, the hot-pressing occurs at a temperature of about 60° C. to 180° C. depending on the binder type and with pressure of about 2 to 5 tons. Depending on the thermoplasticity characteristics of the binder, the duration of the pressing can vary. It was found that the pressure and the length of time the pressure is applied depends on the film/pellet thickness. It was discovered that excessive pressure causes cracking on the electrode surface which degrades the interface between the electrode and the electrolyte. This degradation of the interface between the electrode and the electrolyte in turn reduces battery performance. After hot pressing, the pressed material on the substrate 115 is cooled naturally without an external cooling source. It was found that this slow cooling process reduces fractures in the resulting electrode or electrolyte. It was discovered that fast or instant cooling tends to shrink or bend the electrode which in turn creates fractures. In the example illustrated in FIG. 4, the dry mixture powder 405 in the powder layer 410 is cured. The reciprocating hot press 150 of the press 145 at the curing station 125 is heated and pressed against the powder layer 410 on the substrate 115. The powder layer 410 and substrate 115 is pressed between the heated reciprocating hot press 150 and the heated support plate 155 such that the binder in the powder layer 410 cures. At a certain temperature both active material and binder become fused together to create a uniform electrode or electrolyte fused layer 415. The thickness of the electrode fused layer 415 can be around 200 μm, including the current collector, or up to 50 μm as a free-standing layer. In other embodiments, a UV activated binder may be used. In this instance, a UV lamp is located at the curing station 125 right before the press 145.

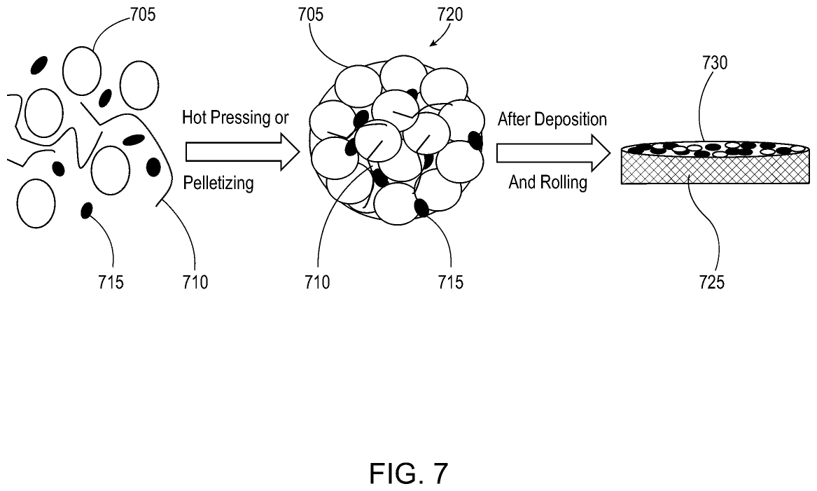

An electrical charge can be further applied to the substrate for attracting the constituent particles in the electrode mixture. The electrical charge is applied to the constituent particles, and the constituent particles are distributed uniformly across a width based on a size of a battery cell receptive to the planar substrate. Using a high pressure deposition (pelletizing) technique at room temperature (about 25° C.) can prevent the thermal decomposition of the active material, and the granular powder transforms to a free standing compacted, dense electrode. During application of the high pressure (600 MPa to 1 GPa), all loose cathode components (active material, binder, carbon nano material, etc.) are compacted and form a composite uniform film/pellet without segregation, as will be described below with respect to FIG. 7. In another embodiment, the dry electrode mixture can be dispensed onto a mold. The mold can have an array of receptacles, each receptacle defining a shape and a spacing from adjacent receptacles to form molded structures on the substrate. The mold can be inverted onto the substrate, so as the molded structures are released onto the substrate for forming a deposition pattern on the substrate corresponding to the array. In one example, the mold can be a cylindrical roller adapted to receive the dispensed dry electrode mixture into the receptacles and to invert the receptacles by rotation to a release position onto the substrate. The substrate can be operable for conveyance at a speed corresponding to the rotation. A scraper can be further applied across a top surface of the mold.

In stage 335, the fused layer 415 on the substrate 115 is calendared to ensure the target electrode (or electrolyte) thickness and provides additional adhesiveness for the solvent free electrode sheet. The calendaring helps to increase the tortuosity and the diffusion rate of Lithium during cycling which in turn provides better electrochemical performance. It was discovered that a 20-30% reduction of the original film thickness from the calendaring process for the electrode helped to provide this enhanced electrochemical performance. Referring to FIG. 4., the substrate 115 and fused layer 415 are pressed or squeezed between the calendaring rollers 160 at the calendaring station 130. In other examples, calendaring is not used. The additional pressure enhances the adhesiveness between the active material and current collector. This pressure also helps to reduce the ionic tortuosity by reducing the thickness of the electrode and eliminating voids.

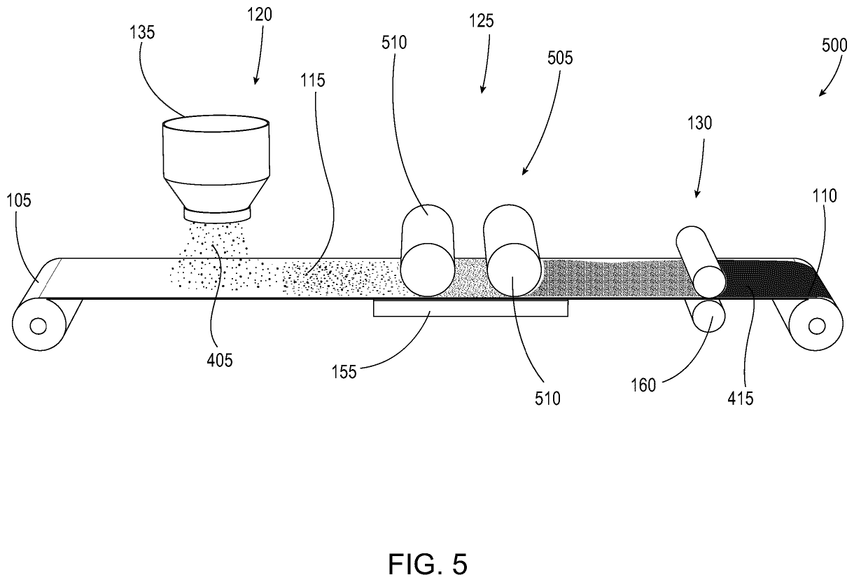

FIG. 5 illustrates another system 500 configured to perform the solvent-free manufacturing process described above with reference to the flowchart 300 in FIG. 3. The system 500 in FIG. 5 shares several components in common with the system 100 shown in FIG. 1. For the sake of clarity as well as brevity, these components will not be again described in detail, but please refer to the previous discussion.

Like in FIG. 1, the system 500 includes the supply roll 105, the take up roll 110, and the substrate 115 that is fed from the supply roll 105 to the take up roll 110. The system 500 includes the deposition station 120, the curing station 125, and the calendaring station 130. The dry binder material, dry conductive material and dry active particles are ground and blended to form a dry mixture powder up to targeted particle size. The dry electrode mixture is a result from a combination of a plurality of types of constituent particles, including at least an active charge material and a binder. The dry active material is ball milled at approximately 20 Hz for about 30 minutes with carbon material, dry conductive particles, and dry binder material. The dry binder material, dry conductive material and dry active particles are then ground for about 15 to 20 minutes at about 1000 to 2000 rpm to form a dry mixture up to a targeted particle size. In one version the targeted particle size is about 2 to 20 μm in size. The mixing of the different powder materials in one version is achieved mechanically, such as via stirring and/or rotating drums for deposition. The deposition station 120 has the hopper 135 with the membrane 140 configured to disperse the dry powder 405 onto the substrate 115 that forms the electrodes and/or solid-state electrolyte. This transformation provides uniform dispersion on the current collector surface. The hopper 135 at the deposition station 120 dispenses the blended powder 405 onto the substrate 115 by sifting the powder 405 through the membrane 140 (FIG. 1) in stage 325 to form the powder layer 410 on the substrate 115.

The membrane 140 has microporous membranes or channels to enhance the uniform deposition of the battery materials. The membrane 140 can be one of a variety of configurations. For example, the membrane 140 can include a mesh, sieve, grid or lattice. Each of the micropores and/or microchannels in the membrane 140 has a size of 10 μm to 300 μm. The diameter of the membrane 140 in one form is 20 cm. In other forms, this size of membrane 140 can vary from 5 cm to 100 cm depending on the desired width of the substrate 115. Since the uniform dispersion can be achieved with the micropores or microchannels, the particles do not need to be aerated or fluidized. Again, the clearance distance between the hopper 135 and the substrate 115 in one example is around 10 cm. In some embodiments, the substrate 115 can support a current collector and/or electrode. Once more, the dispersion rate can be around 25 mg/sec, and the electrode loading can be 6 mg/cm² after the hot pressing. The dispersion rate again depends upon several factors, such as the particle size, the size of the micropores/microchannels defined in the membrane 140, the pressure applied, the dispensing velocity of the powder 405, and the velocity of the substrate 115 relative to the hopper 135.

The supply roll 105 and take up roll 110 then provide a conveyance of powder 405 on the substrate 115 from deposition station 120 to curing station 125. In the curing station 125, the deposited mixture is heated to activate the binder for adhering the mixture to the substrate, and the deposited mixture is compressed to a thickness for achieving an electrical conductivity of the compressed, deposited mixture as an electrode in a battery. In the illustrated example, the curing station 125 has a hot roller-plate press 505 in the form of one or more heated rollers 510. The hot roller-plate press 505 cures and binds the powder 405 on the substrate 115 by heating and pressing the powder 405 on the substrate 115 between the heated rollers 510 and the heated support plate 155. The hot roller-plate press 505 occurs at a temperature of about 60° C. to 180° C. depending on the binder type and with pressure of about 2 to 5 tons. Depending on the thermoplasticity characteristics of the binder, the duration of the pressing can vary. At a certain temperature both active material and binder become fused together to create a uniform electrode or electrolyte fused layer 415. The thickness of the electrode fused layer 415 can be around 200 μm, including the current collector, or up to 50 μm as a free-standing layer. In an optional embodiment, the calendaring station 130 has the calendaring rollers 160 that further squeeze and/or press the cured fused layer 415 on the substrate 115. The additional pressure enhances the adhesion between the active material and current collector. This pressure also helps to reduce the ionic tortuosity by reducing the thickness of the electrode and eliminating voids.

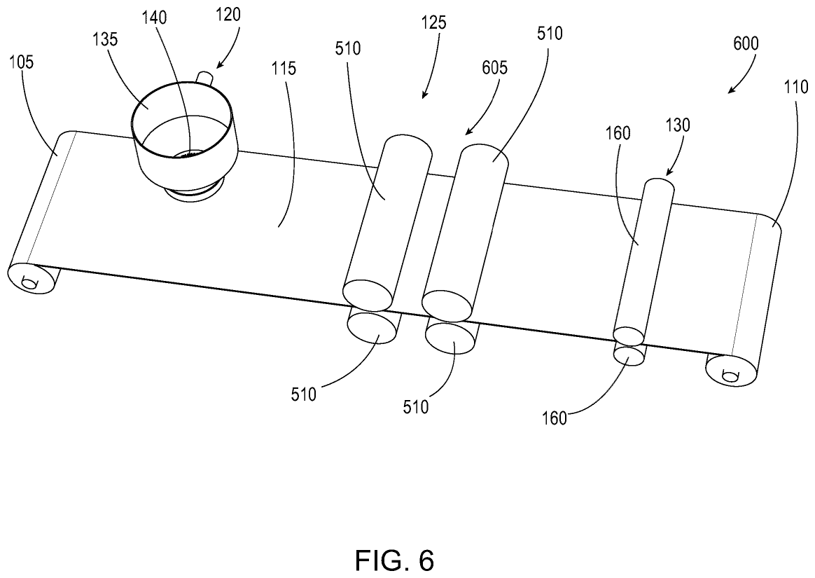

FIG. 6 illustrates another system 600 configured to perform the solvent-free manufacturing process described above with reference to the flowchart 300 in FIG. 3. The system 600 in FIG. 6 shares several components in common with the systems shown in FIGS. 1 and 5. For the sake of clarity as well as brevity, these components will not be again described in detail, but please refer to the previous discussion.

The system 600 includes the supply roll 105, the take up roll 110, and the substrate 115 that is fed from the supply roll 105 to the take up roll 110. The system 600 includes the deposition station 120, the curing station 125, and the calendaring station 130. The dry binder material, dry conductive material and dry active particles are ground and blended to form a dry mixture powder up to a targeted particle size. The dry electrode mixture results from a combination of a plurality of types of constituent particles, including at least an active charge material and a binder. The dry active material is ball milled at approximately 20 Hz for about 30 minutes with carbon material, dry conductive particles, and dry binder material. The dry binder material, dry conductive material and dry active particles are then ground for about 15 to 20 minutes at about 1000 to 2000 rpm to form a dry mixture up to a targeted particle size. In one version the targeted particle size is about 2 to 20 μm in size. The mixing of the different powder materials in one form is achieved mechanically, such as via stirring and/or rotating drums for deposition. The deposition station 120 has the hopper 135 with the membrane 140 configured to disperse the powder 405 onto the substrate 115 that forms the electrodes and/or solid-state electrolyte. This transformation provides uniform dispersion on the current collector surface. The hopper 135 at the deposition station 120 dispenses the blended powder 405 onto the substrate 115 by sifting the powder 405 through the membrane 140 (FIG. 1) in stage 325 to form the powder layer 410 on the substrate 115.

The membrane 140 has micropores and/or microchannels to enhance the uniform deposition of the battery materials. The membrane 140 can come in a variety of configurations. For instance, the membrane 140 can include a mesh, sieve, grid or lattice. The micropores or microchannels of the membrane 140 each has a size (i.e., hydraulic diameter) of about 10 μm to 300 μm. The diameter of the membrane 140 in one form is 20 cm. However, this size of membrane 140 can be different in other variations. For example, the membrane 140 in other variations has a diameter from 5 cm to 100 cm depending on the desired width of the substrate 115. Since the uniform dispersion can be achieved with the micropores or microchannels, the particles do not need to be aerated or fluidized. In one example, the clearance distance between the membrane 140 of the hopper 135 and the substrate 115 in some cases is around 10 cm. In some embodiments, the substrate 115 can include a current collector and/or an electrode. The dispersion rate can be around 25 mg/sec, and the electrode loading can be 6 mg/cm² after hot pressing. It was found that the dispersion rate depends upon several factors, such as the particle size, micropores/microchannels of the membrane, the pressure applied to the powder 405, and the dispensed velocity of the powder 405.

The supply roll 105 and take up roll 110 then convey the powder 405 on the substrate 115 from the deposition station 120 to curing station 125. In the curing station 125, the deposited mixture is heated to activate the binder for adhering the mixture to the substrate, and the deposited mixture is compressed to a thickness for achieving an electrical conductivity of the compressed, deposited mixture sufficient to function as an electrode in a battery. In the illustrated example, the curing station 125 has a hot roller press 605 in the form of one or more heated rollers 510 disposed on opposite sides of the substrate 115. The hot roller press 605 cures the powder 405 on the substrate 115 by heating and pressing the powder 405 on the substrate 115 between the heated rollers 510. The hot roller press 605 occurs at a temperature of about 60° C. to 180° C. depending on the binder type and with pressure of about 2 to 5 tons. Depending on the thermoplasticity characteristics of the binder, the duration of the pressing can vary. At a certain temperature both active material and binder become fused together to create a uniform electrode or electrolyte fused layer 415. The thickness of the electrode fused layer 415 can be around 200 μm, including the current collector, or up to 50 μm as a free-standing layer. In an optional embodiment, the calendaring station 130 has the calendaring rollers 160 that further squeeze and/or press the cured fused layer 415 on the substrate 115. The additional pressure enhances the adhesion between the active material and current collector. This pressure also helps to reduce the ionic tortuosity by reducing the thickness of the electrode and eliminating voids.

FIG. 7 depicts a transformation of powder format material to thick film electrode/pellet using hot pressing or high-pressure pelletizing techniques. A granular powder material is provided including an active material 705, a binder 710, and a carbon component 715. A high pressure deposition (pelletizing) technique at room temperature (25° C.) can prevent the thermal decomposition of the active material, and the granular powder transforms into a free standing compacted, high density electrode. During application of high pressure (600 MPa to 1 GPa), all loose cathode components (e.g., the active material 705, the binder 710, the carbon component 715 etc.) are compacted and formed into a composite uniform pellet 720 or film without segregation due to particle agglomeration. Deposition and rolling of the composite uniform pellet 720 on a current collector 725 further results in a solvent-free electrode 730 or electrolyte production.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example, if the stated value is 4.375, then use of the term “about 4.375” generally means a range between 3.9375 and 4.8125.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Anode” means a terminal of a diode through which current enters the diode when the diode is forward biased.

“Battery” generally refers to a device that converts chemical energy into electrical energy. The battery stores energy in chemical form and then discharges the energy by converting chemical energy into electricity. The battery generally includes one or more electrochemical cells and terminals. The terminals usually include an anode and a cathode.

“Binder” generally refers to a material or substance that holds or draws other materials together to form a cohesive whole mechanically, chemically, by adhesion or cohesion.

“Calendar Roller” or “Calendar Roll” generally refers to a hard pressure roller used to finish or smooth a sheet of material such as paper, textiles, and/or films. The calendar rollers are used to squeeze the sheet of material.

“Channel” generally refers to a long, narrow groove in a surface of an object.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Electrode” generally refers to an electrical conductor used to make contact with a nonmetallic part of a circuit (e.g., a semiconductor, an electrolyte, a vacuum or air). For example, electrodes are parts of batteries that can include a variety of materials depending on the type of battery.

“Flat” generally refers to an object having a broad level surface but with little height.

“Hole” generally refers to a hollow portion through a solid body, wall or a surface. A hole may be any shape. For example, a hole may be, but is not limited to, circular, triangular, or rectangular. A hole may also have varying depths and may extend entirely through the solid body or surface or may extend through only one side of the solid body.

“Hydraulic Diameter” generally refers to a characteristic dimension that equates non-circular channels or tubes, like rectangular or triangular channels, to a circular channel having the same flow behavior. In some cases, the hydraulic diameter refers to the diameter of a circle with the same cross-sectional area as the channel in question.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Microchannel” generally refers to a miniaturized groove with a hydraulic diameter of less than 1 millimeter. Typically, the hydraulic diameter ranges in the micrometer and the nanometer range. Microchannels can have various longitudinal shapes, such as straight and curved shapes, and the microchannels can also have various cross-sectional shapes, such as rectangular, trapezoidal, regular, and irregular shapes.

“Micropore” generally refers to a hole that extends through a material with a hydraulic diameter ranging from micrometers to nanometers in size. Micropores can have various shapes, including those having circular, rectangular, regular, and irregular cross-sectional shapes.

“Mixture” generally refers to a material made up of two or more different chemical substances which are not chemically bonded. A mixture is the physical combination of two or more substances in which the identities are retained and are mixed in the form of solutions, suspensions and colloids.

“Or” generally refers to a conjunction that is indicative of two or more alternatives. In other words, the word “or” connects words, phrases, and/or clauses that offer different possibilities. Usually, but not always, the word “or” only appears before the last alternative in a series of alternatives.

“Powder” generally refers to a dry, bulk solid composed of many very fine particles that may flow freely when shaken or tilted.

“Roller” generally refers to a cylindrically shaped material handling component that is able to revolve. Typically, but not always, the roller is configured to provide mechanical power transmission, a conveying surface, and/or support for conveyed objects or items. The roller can be powered or unpowered.

“Size” generally refers to the extent of something; a thing's overall dimensions or magnitude; how big something is. For physical objects, size may be used to describe relative terms such as large or larger, high or higher, low or lower, small or smaller, and the like. Size of physical objects may also be given in fixed units such as a specific width, length, height, distance, volume, and the like expressed in any suitable units. For data transfer, size may be used to indicate a relative or fixed quantity of data being manipulated, addressed, transmitted, received, or processed as a logical or physical unit. Size may be used in conjunction with the amount of data in a data collection, data set, data file, or other such logical unit. For example, a data collection or data file may be characterized as having a “size” of 35 Mbytes, or a communication link may be characterized as having a data bandwidth with a “size” of 1000 bits per second.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 supply roll
110 take up roll
115 substrate
120 deposition station
125 curing station
130 calendaring station
135 hopper
140 membrane
145 press
150 reciprocating hot press
155 support plate
160 calendaring rollers
300 flowchart
305 stage
310 stage
315 stage
320 stage
325 stage
330 stage
335 stage
405 powder
410 powder layer
415 fused layer
500 system
505 hot roller-plate press
510 heated rollers
600 system
605 hot roller press
705 active material
710 binder
715 carbon component
720 composite uniform pellet
725 current collector
730 electrode

1. A system, comprising:
a supply roll configured to supply a substrate;
a deposition station configured to dispense a dry mixture onto the substrate;
wherein the dry mixture includes carbon particles, conductive particles, and dry binder particles;
wherein the deposition station defines micro-sized openings through which the dry mixture is uniformly deposited onto the substrate; and
a curing station configured to bind the binder particles with the carbon particles and the conductive particles to form a solid layer of the dry mixture on the substrate.

2. The system of claim 1, wherein the deposition station has a microporous membrane.

3. The system of claim 1, wherein the micro-sized openings have a size of about 10 μm-300 μm.

4. The system of claim 1, wherein the micro-sized openings include micropores.

5. The system of claim 1, wherein the micro-sized openings include microchannels.

6. The system of claim 1, wherein the deposition station has a drum or shaft with micropores or microchannels.

7. The system of claim 1, further comprising:
a milling station configured to mill the dry mixture;
wherein the milling station is configured to supply the dry mixture to the deposition station; and
wherein the milling station includes a ball miller configured to ball mill the dry mixture.

8. The system of claim 1, wherein:
the curing station includes a press; and
the press includes a hot reciprocating plate type press.

9. The system of claim 1, wherein:
the curing station includes a press; and
the press includes a hot roller-plate type press.

10. The system of claim 1, wherein:
the curing station includes a press; and
the press includes a hot roller type press.

11. The system of claim 1, wherein:
the curing station includes a press; and
the press has a temperature of about 60° C. to 200° C.

12. The system of claim 1, wherein the curing station includes ultraviolet curing equipment.

13. The system of claim 1, further comprising a calendaring station configured to flatten the solid layer of the dry mixture on the substrate.

14-21. (canceled)
